(19) United States
(12) Patent Application Publication
(10) Pub. No.: US 2025/0110304 A1
(43) Pub. Date: Apr. 3, 2025

(54) FIBER OPTIC TERMINALS HAVING A MULTI-FIBER INPUT OPTICAL CONNECTION PORT AND OUTPUT PORTS

(71) Applicant: CORNING RESEARCH & DEVELOPMENT CORPORATION, CORNING, NY (US)

(72) Inventors: Michael De Jong, South Mountain, PA (US); Ashley Wesley Jones, Denton, TX (US); Gordon Mueller-Schlomka, Berlin (DE); Edward Joseph Carroll, Hickory, NC (US); Shane Blackburn Harmon, Statesville, NC (US); Darin Gregory Howe, Denver, NC (US); Jason Anthony Lewis, Hickory, NC (US)

(21) Appl. No.: 18/897,947

(22) Filed: Sep. 26, 2024

Related U.S. Application Data
(60) Provisional application No. 63/541,542, filed on Sep. 29, 2023.

(51) Int. Cl. G02B 6/44

(52) U.S. Cl. CPC G02B 6/4471; G02B 6/44785

(57) ABSTRACT

Fiber optic terminals comprising an input connection port in optical communication with an input multi-fiber ferrule of the input connection port and a plurality of output ports for making optical connections are disclosed. The terminals are configured with an input multi-fiber connection port and one or more single-fiber output ports along with a first multifiber output connection port suitable for linking the output of the first terminal with an input connection port of a second terminal. The multi-fiber connection port may include an alignment block supports a length of the adapter sleeve for stabilizing the optical mating of the multi-fiber ferrule associated with respective multi-fiber connection port(s) of the terminal. Terminals may also include other features for securing respective the external plug connector(s) that may be received in the connection port of the fiber optic terminal.

### RELATED APPLICATIONS

This application claims the benefit of priority of U.S. Provisional Application Ser. No. 63/541,542 filed on Sep. 29, 2023, the content of which is relied upon and incorporated herein by reference in its entirety.

### FIELD

The disclosure is directed to fiber optic terminals having a multi-fiber input connection port and a multi-fiber output connection port along with one or more drop-connection ports for optical mating using external multi-fiber plug connectors that are received by the respective connection ports for optical communication networks.

### BACKGROUND

Optical fiber is increasingly being used for a variety of applications, including but not limited to broadband voice, video, and data transmission. As bandwidth demands increase optical fiber is migrating deeper into communication networks such as in fiber to the premises applications such as FTTx, 5G and the like. As optical fiber extended deeper into communication networks the need for making robust optical connections in outdoor applications in a quick and easy manner was apparent. To address this need for making quick, reliable, and robust optical connections in communication networks hardened fiber optic connectors such as the OptiTap® plug connector were developed.

Terminals such as multiports were also developed for making an optical connections with hardened connectors such as the OptiTap connector. Prior art terminals such as depicted in FIG. 1 have a plurality of receptacles for mating OptiTap connectors. The receptacles are mounted through a wall of the housing of the terminal of FIG. 1 for protecting an indoor connector inside the housing that makes an optical connection to the external hardened connector of a branch or drop cable.

Conventional fiber optic multiports have an input fiber optic cable carrying one or more optical fibers to indoor-type connectors inside a housing. The conventional multiport receives the optical fibers from the input fiber optic into housing and distributes the optical fibers to a plurality of receptacles or ports for connection with an external hardened connector. The receptacles are separate assemblies attached through a wall of housing of the multiport, and all of the receptacles typically have the same connector interface. The receptacles or ports allow mating with external hardened connectors having the same connector footprint. The external hardened connectors are attached to drop or branching cables such as drop cables for “fiber-to-the-home” applications for routing optical signals toward the subscriber. During use, optical signals pass through the branch cables, to and from the fiber optic cable by way of the optical connections at the receptacles or ports of conventional multiport. Conventional multiports allowed quick and easy deployment for optical networks.

Consequently, there exists an unresolved need for terminals that allow flexibility for the network operators to quickly and easily make multi-fiber optical connections among terminals in their optical network that provide a robust connection while meeting the robust handling along with extreme field-conditions and environments for preserving the optical performance of the optical connections, and especially multi-fiber connections.

### SUMMARY

The disclosure is directed to fiber optic terminals (hereinafter “terminals”) with internal optical wiring for making a multi-fiber optical connection at an input connection port of the terminal having the optical fibers wired to other connection ports of the terminal. The terminal comprises at least one input connection port supporting a plurality of input optical fibers sequentially numbered 1 to X and disposed within a cavity of the shell of the terminal. The plurality of input optical fibers sequentially numbered 1 to X being disposed in an input multifiber ferrule comprising a plurality of optical fiber openings sized for receiving the respective input optical fibers sequentially numbered 1 to X into the plurality of optical fiber openings of the input multi-fiber ferrule that are numbered sequentially 1 to X. A wiring scheme of the terminal comprises D-number of output drop connection ports where the D-number of output drop connection ports terminating respective input optical fibers are sequentially numbered from 1 to the input optical fiber sequentially numbered D for routing to the optical connection at the respective output drop connection port. A first multifiber output connection port terminating the respective input optical fibers sequentially numbered from D+1 input optical fiber to the input optic fiber sequentially numbered the X input optical fiber of the plurality of input optical fibers for optical connection at the first multifiber output connection port, the plurality of input optical fibers sequentially numbered D+1 to X being disposed in an output multi-fiber ferrule comprising a plurality of optical fiber openings sized for receiving the respective input optical fibers sequentially numbered D+1 to X into the plurality of optical fiber openings of the output multi-fiber ferrule numbered sequentially from D+1 to X.

The terminals are suitable for connecting in series with other like terminals using the first multifiber output connection port as a multi-fiber pass-thru port to connect with a second terminals using a jumper cable. For instance, the first terminal may be optically connected from the first multifiber output connection port to a second terminal at an input optical connection port using the jumper cable for an optical network. Further, the D-number of output drop connection ports may each provide optical connectivity to a single input optical fiber of the terminal if desired.

Terminal embodiments disclosed may also include an adapter sleeve that cooperates with an alignment block that is associated with the multi-fiber connection port. The alignment block may comprise a first alignment block passageway that is sized for receiving a portion of adapter sleeve for providing extended axial alignment and support for the adapter sleeve of the respective multi-fiber connection port. The terminal embodiments disclosed may use one or more dedicated alignment blocks each having one or more respective alignment block passageways for receiving a portion of respective adapter sleeves, thereby making the terminal concepts scalable and modular as desired. For instance, a 4-port terminal may use as single alignment block with four respective passageways with each passageway cooperating with a dedicated alignment sleeve for each of the four multifiber connection ports of the terminal or a 4-port terminal may use as four dedicated alignment blocks each having a respective passageway for cooperating with a dedicated adapter sleeve for the four multi-fiber connection ports of the terminal.

Other variations of terminals beyond the explanatory embodiments are also possible. For instance, although the explanatory terminals disclosed use push-button securing features, but the concepts disclosed may be used with any desired terminal design for securing the external connector in a quick, efficient and simple manner such as threads, bayonets or the like. Likewise, the explanatory terminal uses a shell that forms a portion of the multi-fiber connection port along with a push-button release for the external connector, but other variations of terminals are possible that do not use the shell as a portion of the multi-fiber connection port according to the concepts disclosed herein. Terminals or devices that may use the concepts disclosed herein include closures, network interface devices, wireless devices or the like. Methods of making the terminals or devices are also disclosed. The terminals may also have any suitable construction such as disclosed herein and may also further include such a multi-fiber connection port that is configured or inhibiting a non-compliant connector such as a single-fiber connector from being inadvertently inserted into the multi-fiber connection port and potentially causing damage to optical mating interface.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure and are incorporated into and constitute a part of this specification. The drawings illustrate various embodiments and together with the description serve to explain the principles and operation.

### BRIEF DESCRIPTION OF THE FIGURES

FIG. 1 is a perspective view of a prior art multiport for making an optical connection comprising receptacles that are attached to the enclosure wall of the prior art terminal;

FIG. 2 is a perspective view of an explanatory terminal having a plurality of multi-fiber connection ports disposed on the terminal and useful with for the concepts disclosed;

FIGS. 3A and 3B depict internal wiring schemes for the terminal of FIG. 2 having an input multi-fiber connection port, D-number of drop connection ports, and a pass-through multi-fiber output connection port with external fiber optic connectors received in the connection port of FIG. 3B;

FIG. 3C shows the multiple terminals with the wiring scheme of FIGS. 3A and 3B being daisy-chained from the pass-through multi-fiber output connection port of the first terminal to the input connection port of the second terminal using a jumper cable for an optical network;

FIG. 3D depicts the concept of FIG. 3C with the daisy-chain spanning multiple terminals by optically connecting the multi-fiber output connection port of the preceding terminal to the input connection port of the subsequent terminal for an optical network connecting terminals using jumper cables.

FIG. 4 is an exploded and sectional view of the explanatory terminal of FIG. 2 having the connection port for supporting a multifiber ferrule;

FIG. 5 is a longitudinal assembled sectional view taken through the multi-fiber connection port of the explanatory terminal of FIG. 4 that is configured for mating with a complimentary external multi-fiber connector;

FIG. 6 is a close-up perspective assembled sectional view taken through the multi-fiber connection port of the explanatory terminal of FIG. 4;

FIG. 7 is a front perspective view of an explanatory alignment block comprising a first alignment block passageway extending between a forward end and a rearward end of the alignment block;

FIGS. 8 and 9 are sectional and front views of the explanatory alignment block shown in FIG. 7;

FIG. 10 is a front perspective view of an explanatory adapter sleeve that is useful with the alignment block of FIG. 7;

FIG. 11 is a rear perspective view of an explanatory adapter sleeve of FIG. 10;

FIGS. 12 and 13 respectively are sectional and front views of the explanatory adapter sleeve of shown in FIGS. 10 and 11; and

FIG. 14 is a perspective view showing another explanatory sub-assembly having an explanatory alignment block with the extended length support comprising a first alignment block passageway assembled with the other components associated with the multi-fiber connection port.

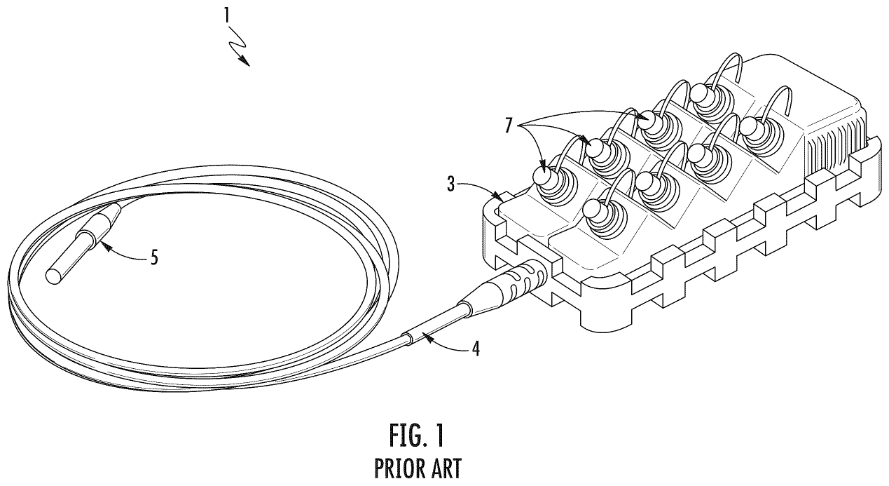

### DETAILED DESCRIPTION

Reference will now be made in detail to the embodiments of the disclosure, examples of which are illustrated in the accompanying drawings. Whenever possible, like reference numbers will be used to refer to like components or parts.

The terminals disclosed herein comprise connection ports comprising multi-fiber optical connection ports suitable for mating external multi-fiber plug connectors along with single-fiber optical connection ports using suitable for mating external single-fiber plug connectors for indoor, outdoor or other environments as desired. Generally speaking, the devices disclosed and explained in the exemplary embodiments are terminals having both an input and output multifiber optical connection ports and a plurality of single-fiber connection ports and are useful for optical networks and systems.

The explanatory terminals comprise a shell defining a cavity for receiving an optical fiber wiring for the optical connection ports of the terminal. The shell defines a portion of the multi-fiber and single-fiber connection ports configured for removably receiving external plug connectors into the respective connection port of the terminal. For instance, the terminal concepts may use any suitable number of multi-fiber connection ports such as one, two, four, eight, twelve or any other suitable numbers of single-fiber connection ports as desired. The optical wiring of the terminals disclosed may include other devices such as splitters, wave-division multiplexers, couplers or the like for wiring the drop single-fiber connection ports with the optical fibers of the input multi-fiber connection port.

The concepts disclosed advantageously allow optically connecting of terminals using jumper cables for optical connectivity from output connection ports of the first terminal to an input connection port on a second terminal having a multi-fiber input connection port.

Likewise, the terminals may comprise any suitable securing feature to engage the external multi-fiber plug connector that is received by the multi-fiber connection port of the terminal. The securing features disclosed by the explanatory terminals engage directly with a portion of the external connector inserted into the connection port without conventional structures on terminals that require the turning of a coupling nut, bayonet or the like for securing the external connector. Moreover, the securing feature of the terminals disclosed may comprise one or more components such a securing member or a securing member and actuator. Thus, the terminals disclosed may allow connection ports to be closely spaced together and may result in relatively small terminals since the room needed for turning a threaded coupling nut or bayonet is not necessary. The compact form-factors may allow the placement of the terminals in tight spaces in indoor, outdoor, buried, aerial, industrial or other applications while providing both multi-fiber connection ports and single-fiber connection ports providing robust and reliable optical connections in a removable and replaceable manner. The disclosed terminals may also be aesthetically pleasing and provide organization for the optical connections in manner that the prior art terminals cannot provide.

Further, the connection port(s) of the terminal may also include a keying portion that cooperates with a key on a complimentary external multi-fiber plug connector to inhibit damage to the multi-fiber connection port by inhibiting the insertion of a non-compliant connector or not. The keying portion may also aid the user during blind insertion of the connector into the connection port of the device to determine the correct rotational orientation with respect to the multi-fiber connection port when a line of sight is not possible or practical for alignment.

The terminals disclosed comprise a securing feature for directly engaging with a suitable portion of a connector housing of the external fiber optic connector or the like for securing an optical connection with the suitable port. The structure for securing the fiber optic connectors in the devices disclosed allows much smaller footprints for both the terminals and the external fiber optic connectors along with a quick-connect feature. Terminals may also have a dense spacing of connection ports if desired. The terminals disclosed advantageously allow a relatively dense and organized array of connection ports in a relatively small form-factor while still being rugged for demanding environments. As optical networks increase densifications and space is at a premium, the robust and small-form factors for terminals such as multiports, closures, wireless devices or the like become increasingly desirable for network operators.

The concepts are shown and described with a terminal having a linear array of connection ports that are optically wired to the input multi-fiber connection port, but other arrangements are possible. The concepts also include a multi-fiber pass-through connection port for chaining an input of a second terminal using a jumper cable for optically connecting to a multi-fiber output connection port of the first terminal as shown. Although, these concepts are described with respect to terminals the concepts may be used with any other suitable terminals or devices such as wireless devices, closures or other suitable devices.

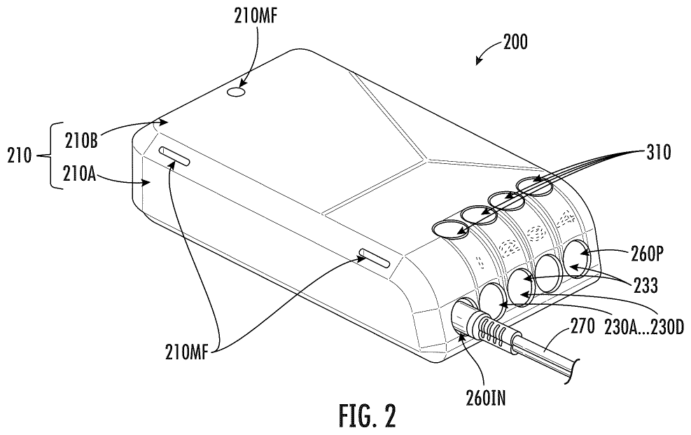

FIG. 2 is a top perspective view of an explanatory terminal 200 having a shell defining a cavity and comprising an input connection port 260IN supporting a plurality of input optical fibers sequentially numbered 1 to X disposed within the cavity of the shell. Terminal 200 also comprises a plurality of single-fiber connection ports 230A-230D and a first multifiber output connection port 260P that sequentially terminates D+1 input optical fibers to the X input optical fiber of the plurality of input optical fibers N+1 to X for optical connection at the first multifiber output connection port. Generally speaking, the first connection port or single-fiber connection port(s) 236 comprise an optical connector opening 236OP extending toward a cavity 216 of the terminal 200 and defining a first connection port passageway such as a single-fiber connection port passageway 236P configured for receiving a first connector such as a single-fiber plug connector for optical connection. The at least one second connection port such as multi-fiber connection port 260 comprises an optical connector opening 260OP extending toward the cavity 216 of the terminal 200 and defining a second connection port passageway such as a multi-fiber connection port passageway 260P configured for receiving a second connector such as a multi-fiber plug connector for optical connection. The multi-fiber connection port 260 inhibits the damaging insertion of the single-fiber plug connector intended for the at least one single-fiber connection port 236 into the at least one multi-fiber connection port 260. The single-fiber connection ports 236 and multi-fiber connection port 260 are configured for receiving and retaining suitable external fiber optic connectors for making optical connections with the different connection ports of the terminal 200 (i.e., the external connectors have different connector mating footprints for the respective first and second connection ports). The connection ports 236,260 of terminal 200 may comprise a portion of any suitable structure such as a shell 210 or the connection ports 236,260 may be independent of the shell or closure if desired.

FIG. 2 depicts a partially exploded view showing one or more optical fibers 250 that provide optical communication from the second connection port(s) such as the multi-fiber connection port 260 to the first connection port(s) such as respective single-fiber connection ports 236 inside terminal 200. Terminal 200 may use one or more optical splitters, couplers, or wavelength multiplexers 275 as depicted or not as desired. The one or more optical fibers 250 may attach to an internal ferrule, connector or the like at the second connection port such as the multi-fiber connection port 260 as an input port and provide optical communication via an internal ferrule, connector or the like at the respective first connection port(s) such as single-fiber connection ports 236 as outputs port for the terminal 200. However, other suitable arrangements are possible for terminal 200 such as no splitters, couplers or the like, multiple splitters, pass-through connection ports, or express connection ports having one or more optical connections for providing the desired optical connectivity. Although, the term “multi-fiber connection port” is used it may only use a single-fiber in a multi-fiber ferrule, connector or the like if desired and represents a second connection port that is different than the first connection port(s). In this embodiment, the multi-fiber connection port comprises a multi-fiber ferrule such as an MT ferrule associated with the connection port and may terminate any suitable number of optical fibers such as one or more optical fibers.

For the sake of simplicity in the description, the explanatory terminals 200 with respect to “single-fiber connection port” representing the “first connection port” and “multi-fiber connection port” representing the “second connection port” for the concepts disclosed. The first connection port or single-fiber connection port and the second connection port or multi-fiber connection port cooperate with different external connector mating footprints for making an optical connection.

By way of further explanation, one or more optical fibers 92IN are routed from the at least one multiple-fiber connection port 260IN toward output drop connection ports 230A-230D for optical communication within and among the connection ports of the terminal 200. For instance, the first sequentially numbered optical fiber of the at least one multifiber connection port 260IN may be terminated at a first single-fiber ferrule for the first drop connection port 260A and the second sequentially numbered optical fiber of the input connection port 260IN may be terminated at a second single-fiber ferrule for the second drop connection port 260A with the remaining input optical fibers 92P routed so they are in optical communication at the first multifiber output connection port 260P. This optical wiring inside the cavity 216 of the terminal 200 among the connection ports may take several different configurations and support unidirectional or bi-direction traffic as desired.

The single-fiber connection ports 236 or multi-fiber connection ports 260 may comprise a marking indicia such as an embossed number or text for identification to the technician, but other marking indicia are also possible. For instance, the marking indicia may be on, or adjacent, to the securing feature 310 such as text or a visible portion of the securing features may be color-coded to indicate fiber count, position, power-level or other relevant information for the technician.

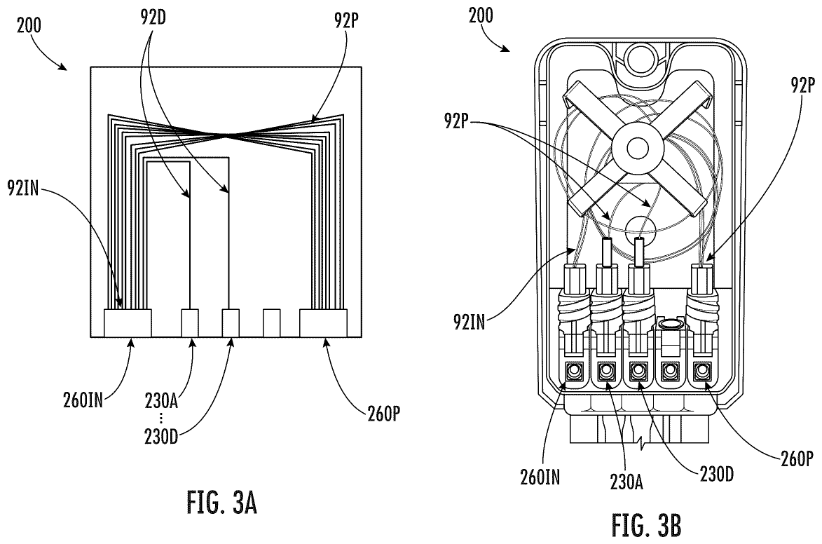

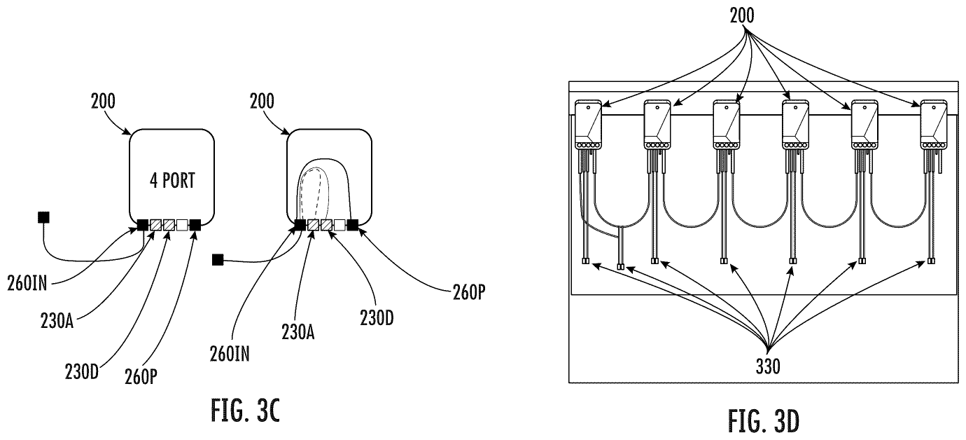

FIG. 3A shows an explanatory fiber optic wiring schematic useful for optically connecting a first terminal 200 with a second terminal 200. As shown the optical wiring has X number of optical fibers 92IN. The X number of optical fibers 92IN are split into optical fibers 92D that feed the single fiber connection ports 230A-230D and the optical fibers 92P that feed the first multifiber connection port. Terminals using the concepts can be daisy-chained together from output port to next terminal input port for mapping designs and building optical networks to existing neighborhoods along with considerations for future growth.

The optical networks and terminal wiring schemes designed for specific neighborhoods or builds are likely to use terminals with variations of optical wiring disposed within the shell of the terminal for tailoring the terminal designs for the build. For instance, four terminals may be daisy-chained together and each terminal has a different optical wiring scheme. This is especially true in rural neighborhoods where the fiber optic cabling traverse greater distances between terminal locations. Consequently, the wiring scheme for the optical network of terminals designed for a particular build may be tailored to the layout of the neighborhood. For instance, the terminals may have different wiring variations that are installed at designated locations for the build since they are using different number of drop ports for the daisy-chained terminals of the optical network. Likewise, the terminals of an optical network may vary the fiber counts for pass-through fibers by varying the number of input optical fibers and output optical fibers. Further, branching of terminals in multiple directions may useful if desired.

FIG. 3B depicts the physical construction for terminal 200 having a portion of the shell removed for showing of the fiber optic wiring of FIG. 3A. In this embodiment, the single-fiber drop output connection ports 230A-230D and the multi-fiber connection ports 260IN,260P each comprises a respective optical connector passageway 233 extending from an opening extending from an outer surface of the shell of the terminal 200 into a cavity 216 of the terminal 200 and defining a portion of respective a connection port passageway 233. By way of explanation, portions of the connection port passageways 233 are molded as a portion of shell 210, but other constructions are possible with the concepts disclosed.

Although one advantageous structure is illustrated and explained for attaching the external connectors to the terminal 200, the concepts disclosed herein may use any suitable structure for attaching the external connectors to the respective connection ports of the terminal 200 such as threads, bayonets or the like if desired.

As shown in FIG. 2, the explanatory terminals 200 may multifiber connection ports 260IN, 260P and single-fiber drop output connection ports 230A-230D as desired. The different connection ports may require different geometry for alignment sleeves and related ferrules and components for implementing the disclosed concepts with distinctly different first and second connection ports of the terminal 200 that cooperate with different external connector mating footprints. However, many of the other components may use similar components such as using the same securing member 310M, securing actuator 310A or securing feature resilient member 310RM for biasing the securing feature toward a retain position as desired.

The terminals 200 disclosed herein advantageously provide a scalable form-factor for manufacturing terminals with different port counts or varying wiring schemes along with other advantages such as quick and easy assembly of terminals in a scalable and efficient manner.

The terminals 200 may comprise a portion of respective securing feature(s) 310 associated with the respective connection ports for providing quick and easy optical connectivity with a robust and reliable design that is intuitive to use. Moreover, the terminals disclosed with multifiber connection ports and single-fiber connection ports may have the benefit of inhibiting the damaging insertion of non-compatible single-fiber external connector intended for the drop output connection ports from being mistakenly inserted and damaging the multifiber connection ports of the terminal. However, the concepts disclosed may similarly be used with terminals having only a plurality of multi-fiber optical connection ports that inhibit non-compliant external connectors from damaging the respective multi-fiber optical connection ports of the terminal.

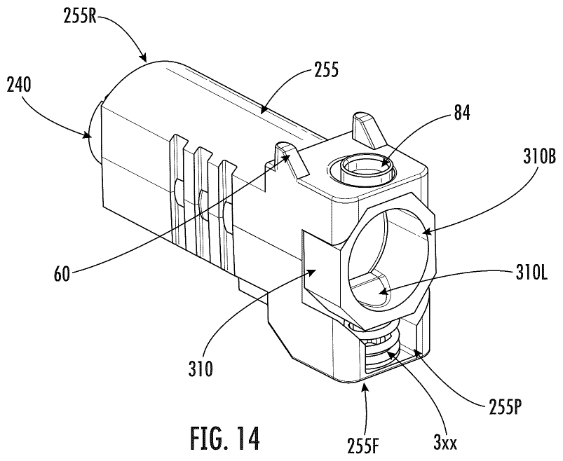

However, the concepts disclosed may be used with a common alignment body configured for supporting a plurality adapter sleeves for the respective connection ports or individual alignment bodies with each alignment body having its own adapter sleeve such as shown in FIG. 14. Supporting the adapter sleeve with the common alignment body does not allow the independent movement like independent bodies for the connection ports of the terminal.

Generally speaking, the respective connection ports may be configured for the specific external connector intended to be received in the respective connection ports. Likewise, the respective connection ports should be configured for receiving the specific internal rear ferrule or connector for providing optical mating the desired external connector.

Optical connections to the terminals 200 are made by inserting one or more suitable external fiber optic connectors into respective connection port passageways 233 as desired. Specifically, the single-fiber connection port passageway is configured for receiving a suitable external single-fiber optic connector of a fiber optic cable assembly (hereinafter cable assembly). Single-fiber connection port passageway 233 is associated with its respective securing feature 310 for retaining (e.g., securing) the single-fiber connector in the terminal 200 for making an optical connection. Likewise, the multi-fiber connection port passageway 233 is configured for receiving a suitable external multi-fiber optic connector 270 as shown in FIG. 2. The multi-fiber connection port passageway is associated with its respective securing feature 310 for retaining (e.g., securing) the multi-fiber connector 270 in the terminal 200 for making an optical connection. The respective securing features 310 advantageously allow the user to make a quick and easy optical connection at the respective connection ports of terminal 200, and the securing feature 310 may also operate as push-buttons for providing a connector release feature when actuated.

As depicted, terminal 200 comprises one securing feature 310 associated with each of the respective single-fiber drop output connection ports 230A-230D for cooperating with suitable external single-fiber optic connector. Likewise, one securing feature 310 is associated with the respective multi-fiber connection ports 260IN,260P for cooperating with suitable external multi-fiber optic plug connector. The securing feature 310 may translate for securing or releasing the respective external fiber optic connectors. The concepts disclosed may also use a securing feature resilient member 310RM for biasing a portion of the securing feature 310 as discussed herein.

Specifically, the respective suitable external connector may be retained within the respective connection port of the terminal 200 by pushing and fully-seating the external connector within the respective connection port. To release the external connector from the respective connection port, the securing feature 310 is actuated by pushing inward and releasing the securing feature 310 from the locking feature on the respective external connector and allowing the connector to be removed from the respective connection port. Stated another way, the at least one securing feature 310 is capable of releasing the connector when a portion of the securing feature 310 translates within a portion of a securing feature passageway 245. The full insertion and automatic retention of the external connector may advantageously allow one-handed installation of the connector by merely pushing the suitable connector into the desired connection port. The terminals 200 disclosed accomplish this connector retention feature upon full-insertion by biasing the securing feature to a retain position. However, other modes of operation for retaining and releasing the external connector are possible according to the concepts disclosed. For instance, the securing feature 310 may be designed to require actuation for inserting the connector; however, this may require a two-handed operation.

Securing feature 310 may be designed for holding a minimum pull-out force for the connector. In some embodiments, the pull-out force may be selected to release the connector before damage is done to the terminal or the connector. By way of example, the securing feature 310 associated with the connection port may require a pull-out force of about 50 pounds (about 220N) before the connector would release. Likewise, the securing feature 310 may provide a side pull-out force for connector for inhibiting damage as well. By way of example, the securing feature 310 associated with the connection ports may provide a side pull-out force of about 25 pounds (about 110N) before the connector would release. Of course, other pull-out forces such as 75 pounds (about 330N) or 100 (about 440N) pounds are possible along with other side pull-out forces.

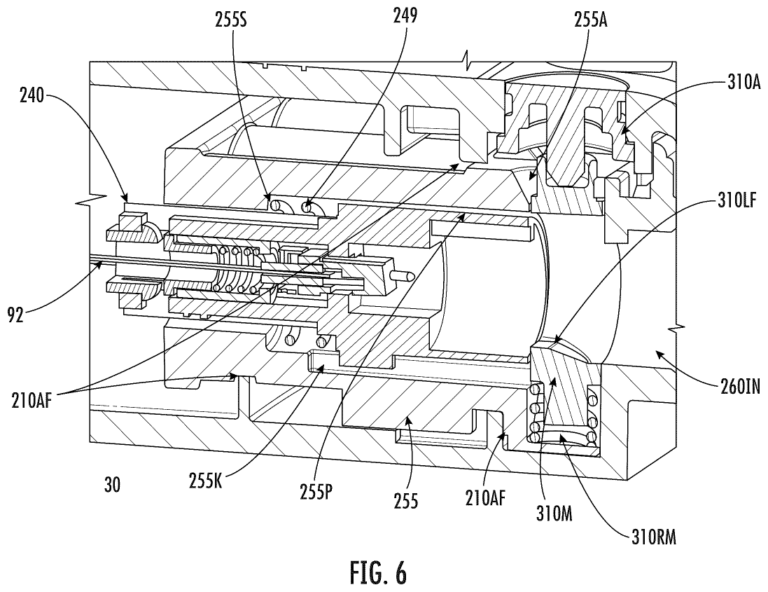

By way of example and FIG. 6, multi-fiber alignment block 255 may comprises a first connector stop (FCS) for inhibiting the damaging insertion of non-compatible external connector suitable for the output drop connection ports 230A-230D from being mistakenly inserted and damaging the input optical connection port 260IN of the terminal. For instance, multi-fiber alignment body 255 may comprises a single-fiber connector stop (SFCS). The single-fiber connector stop (SFCS) is sized for inhibiting the insertion of the external single-fiber plug connector (SFC) into multi-fiber connection ports and causing damage if mistakenly attempted. The alignment sleeve 240 may use any suitable geometry for inhibiting the damaging insertion of the non-compliant external connector suitable for the output drop connection ports.

The alignment sleeve 240A (or the alignment block 255) may comprises the first connector stop (FCS) or single-fiber connector stop (SFCS) for inhibiting the damaging insertion of non-compatible external connector suitable for the single-fiber output drop connection ports 230A-230D from being mistakenly inserted and damaging the input connection port 260IN of the terminal.

For instance, adapter sleeve 240 may comprises a single-fiber connector stop (SFCS). The fiber connection stop (FCS) or single-fiber connector stop (SFCS) is sized for inhibiting the insertion of the single-fiber plug connector (SFC) into the at least one multi-fiber connection port 260IN,260P and causing damage if mistakenly attempted. Adapter sleeve 240 may use any suitable geometry for inhibiting the damaging insertion of the non-compliant external connector such as geometry tailored for inhibiting the damaging insertion of the external connector suitable for the output drop connection ports 230A-230D. In other embodiments, the first connector stop (FCS) may be formed by a combination of components such as the adapter sleeve 240 and multi-fiber adapter body 255 if desired.

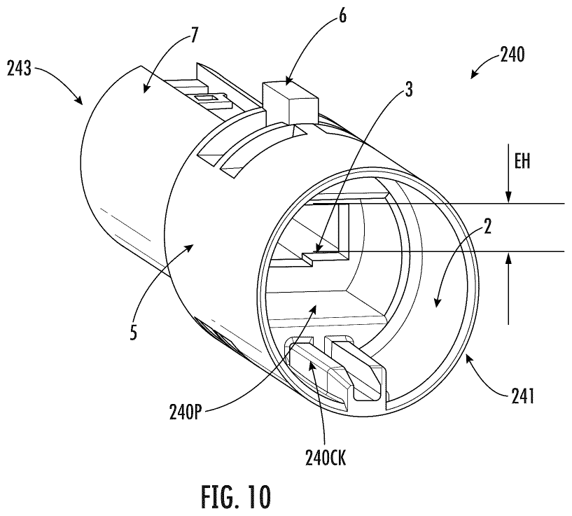

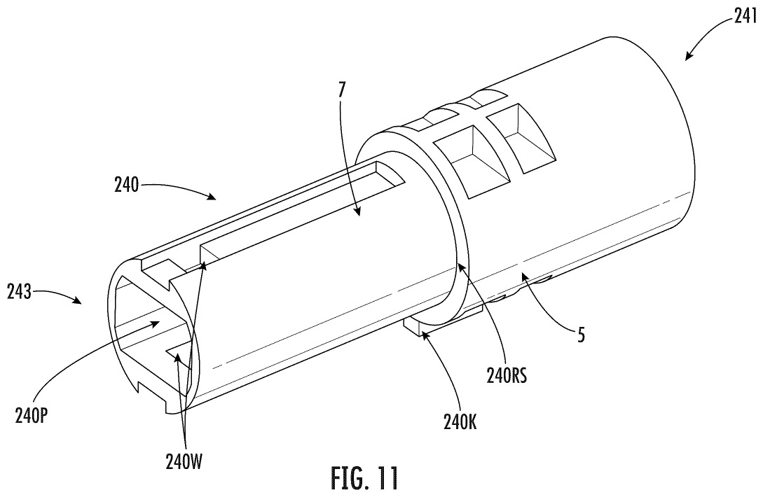

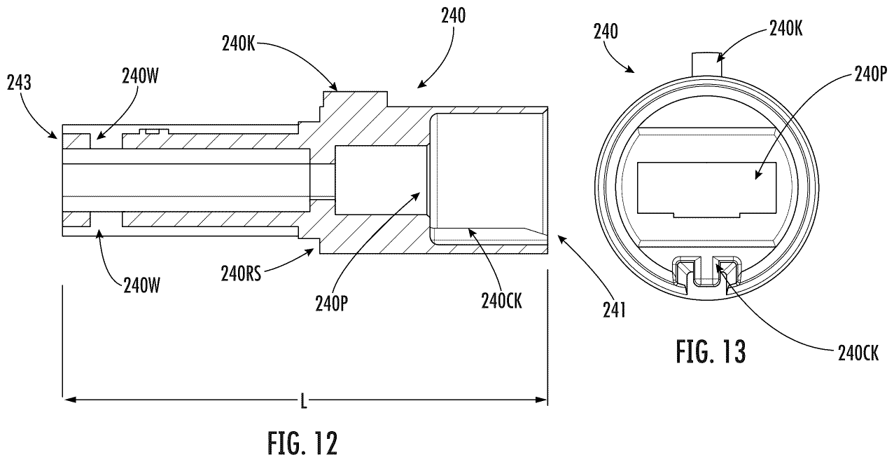

As shown in FIG. 10, the one or more components that comprise the first connector stop may use an exclusion height (EH) tailored to inhibit damaging insertion of the first connector into the second connection port. The exclusion height provides a maximum height dimension for a connector for insertion of an external connector to approach the mating interface. For instance, if the exclusion height was 6 millimeters or less, then only connectors having a height of 6 millimeters or less may pass beyond the exclusion height for approaching the ferrule for the connection port of the terminal.

The use of the exclusion height (EH) inhibits the first external connector suitable for the first connection port from having its ferrule contact (e.g., crash) and damage the ferrule associated with the second connection port. Thus, if the technician mistakenly attempts to insert the single-fiber external connector intended for the output drop connection ports into the multi-fiber connection ports 260IN, 260P, then the single-fiber external connector will not crash the non-compliant external connector in the multifiber connection port, thereby inhibiting damage to the mating face of the ferrule or mating face associated with the connection port. One or more components may comprise an exclusion height (EH) for inhibiting the damaging insertion as well.

In the explanatory embodiments shown, adapter sleeve 240 has a passageway that comprises the exclusion height (EH) of 5.5 millimeters or less for inhibiting the damaging insertion of the first connector that is configured as single-fiber connector with a SC-type front portion into the multifiber connection ports 260IN, 260P. In other embodiments, the exclusion height (EH) may comprises a range of between 5.5 millimeters and 2.5 millimeters, thereby inhibiting the damaging insertion of an external single-fiber connector into the multifiber connection port, but allowing a proper external multifiber connector to make optical communication with the multifiber connection port.

As shown, connection ports of terminals 200 may also comprise a respective ferrule 30, securing member 310M, securing feature resilient member 310RM, an adapter sleeve 240, a resilient member 230RM in addition to other components. Ferrule 30 may be a portion of a standard fiber optic connector package that interfaces with the adapter sleeve 240 may be held in the adapter using suitable structure as desired.

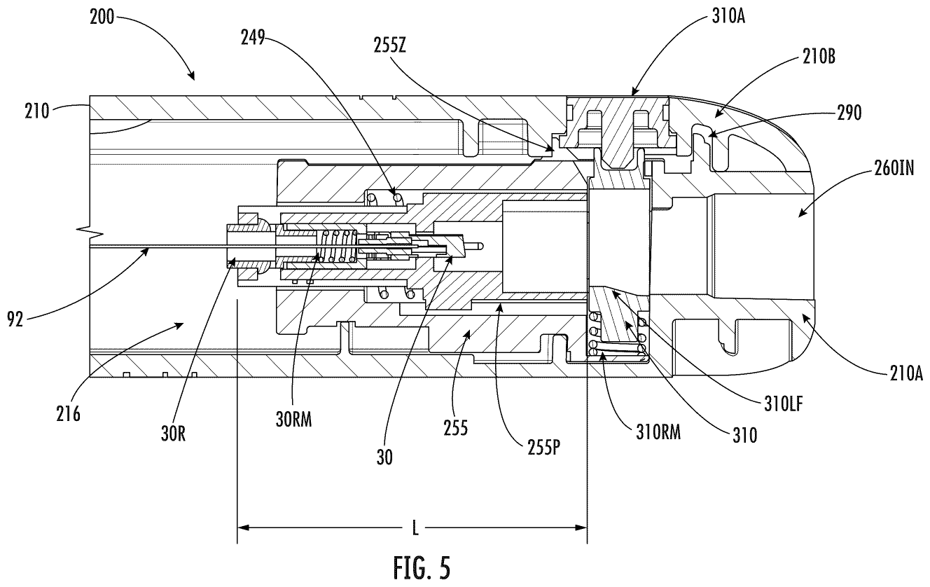

Multifiber ferrule 30 of the input connection port 260IN or the first multifiber output connection port 260P may be configured as an MT or MTP ferrule using alignment pins 30AP for mating with a complementary ferrule of the external multi-fiber connector. The multifiber ferrule 30 may be received and aligned using adapter sleeve 240 suitable for the ferrule. The multifiber ferrule 30 may be a portion of a rear connector such as an MT connector like an MTP® connector, but other connectors are possible. The multifiber ferrule 30 may have any suitable fiber count as desired such as 4-f, 8-f, 12-f, 16-f, 24-f, 32-f in one or more rows on a mating endface. In this embodiment, the rear connector may further comprise a resilient member 30RM and a spring push 30SP held in place within the alignment sleeve 240 using a retainer 30R. As shown in FIG. 5, this ferrule 30 is held in place using spring push 30SP and retainer 30R and biased to a forward position by resilient member 30RM, but other arrangements are possible. As examples, the concepts may be used with terminals having multifiber ferrules 30 with two rows of fiber bores such as with fiber counts of 16-f, 24-f or 32-f. This allows higher fiber counts for the terminals in situations where desired. The securing features 310 disclosed herein may take many different constructions or configurations as desired such as being formed as a single component or a plurality of components. Securing features 310 may be biased by a resilient member 230 RM. Furthermore, the securing features 310 or portions of securing features 310 may be associated with each respective connection port passageway 233 and provide easy and modular assembly of terminal 200.

As best shown in FIG. 5, securing feature 310 is biased to a retain position relative to the external connector received in the connection port. Specifically, the securing feature 310 is biased in an upward direction using a securing feature resilient member 310RM. More specifically, securing feature resilient member 310RM is disposed beneath securing feature 310 for biasing to a normally retain position for the securing feature 310 where the locking feature 310L is disposed in the connection port passageway as shown.

When assembled, a portion of actuator 310A is disposed within a portion of the securing feature passageway 245 and cooperates with the securing member 310M of the respective securing feature. Consequently, a portion of securing feature 310 (i.e., the actuator 310A) is capable of translating within a portion of the securing feature passageway 245. Specifically, the actuator 310A translates in a vertical direction that is in-line with the translation of the securing member 310M in the vertical direction; however, the actuator 310A could be configured to rotate or slide for translating the securing member 310M if desired. In this embodiment, the securing feature 310 is formed from a separate and distinct actuator 310A and securing member 310M as shown, but the actuator 310A and securing member 310M may be formed as a single component.

FIG. 5 depicts the terminal 200 comprising at least one multi-fiber connection port 260 extending from an outer surface 234 of the terminal 200 into a cavity 216 of the terminal 200 and defining a portion of the multi-fiber connection port passageway 260IN, 260P. Terminal 200 may also comprise at least one securing feature 310 associated with the multi-fiber connection port passageway 260P for securing a suitable external connector. Terminal 200 also comprises at least one securing feature passageway 245 associated with the respective connection port for receiving a portion of the securing feature 310. As depicted, the securing feature passageways 245 extends from the outer surface 234 of terminal 200 to cooperate with the respective connection port. The single-fiber connection ports 236 may also have a similar construction.

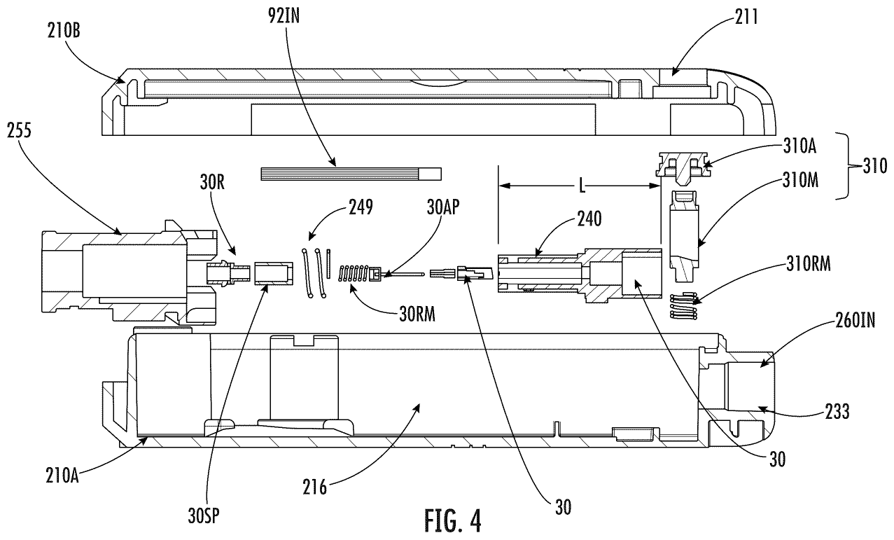

Terminal 200 comprises a shell 210 having a portion of the at least one multi-fiber connection port 260 that is associated with multi-fiber modular adapter sub-assembly 310MSA. FIG. 4 also depicts a detailed sectional view of the interlocking features between the first portion 210A and the second portion 210B of the shell 210. Specifically, portions of the terminal may have a tongue and groove construction for alignment or sealing of the device.

Any of the terminals 200 disclosed herein may optionally be weatherproof by appropriately sealing seams of the shell 210 using any suitable means such as gaskets, O-rings, adhesive, sealant, welding, overmolding or the like. To this end, terminal 200 or devices may also comprise a sealing feature or element 290 disposed between the first portion 210A and the second portion 210B of the shell 210. The sealing feature or element 290 may cooperate with shell 210 geometry such as respective grooves or tongues in the shell 210. Grooves or tongue may extend about the perimeter of the shell 210. By way of explanation, grooves 210G may receive one or more appropriately sized O-rings or gaskets 290 for weatherproofing terminal 200, but an adhesive or other material may be used in the groove 210G. By way of example, the O-rings are suitably sized for creating a seal between the portions of the shell 210. By way of example, suitable O-rings may be a compression O-ring for maintaining a weatherproof seal. Other embodiments may use an adhesive or suitable welding of the materials for sealing the device. If welding such as ultra-sonic or induction welding of the shell is used a special sealing element 290 may be used and then processed to weld the portions together as known in the art. If the terminal 200 is intended for indoor applications, then the weatherproofing may not be required.

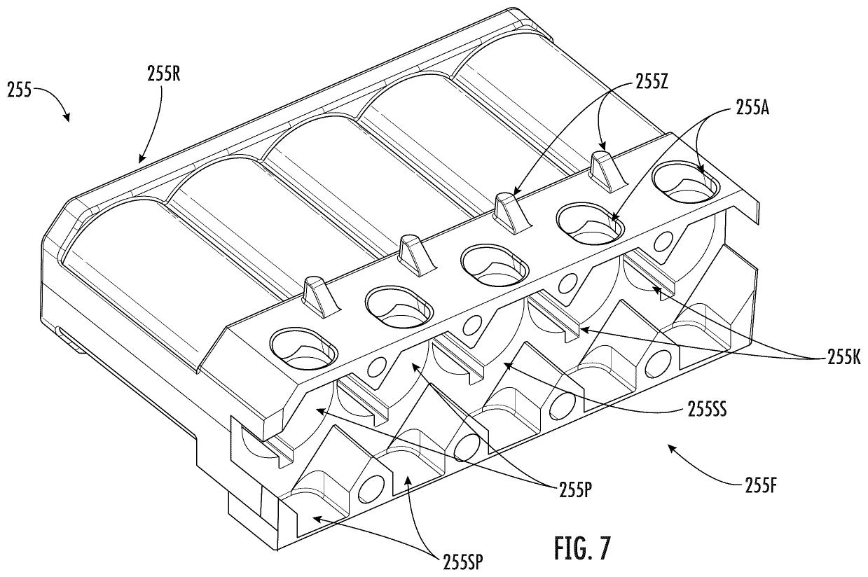

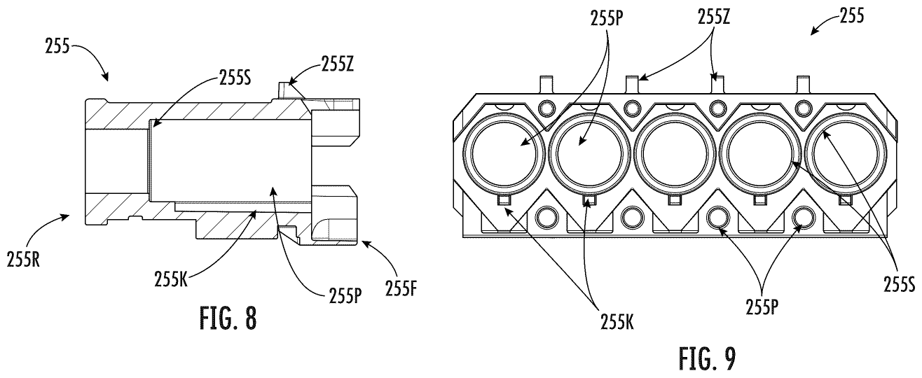

FIGS. 7-9 depict details of the alignment body 255 that receives respective alignment sleeves 240 therein and supports optical connectivity for the respective connection ports. The front end 255F of the alignment body 255M is the side that receives the external connector as it is inserted into the connection port and the front end also receives the alignment sleeves 240. The rear side 255R of the alignment body receives the rear connector disposed inside the cavity of the shell 210.

Alignment body 255 comprises a respective alignment body passageways 255P. When assembled, an adapter sleeve biasing member 249 may be received between the alignment body 255 and the respective alignment sleeve 240 for biasing the alignment sleeve 240 to a forward position. The adapter sleeve 240 may also extend beyond the rearward end 255R of the alignment block 255 when assembled. Other configurations of connection ports may also use the alignment body passageway 255P for receiving the adapter sleeve 240 as an inner barrel for the mating of the optical connection at respective connection port.

As shown in FIGS. 7-9, alignment body 255 comprises alignment features on the top and/or bottom of alignment body 255 that cooperate with the shell 210 to align and seat the same in the shell 210. For instance, alignment body 255 may comprises fingers 255Z that seat the alignment body 255 in the second portion 210B of shell 210 during assembly. Alignment body 255 may also comprise resilient member pocket 255SP at the bottom of the adapter body 255 for capturing the securing feature resilient member 310RM as depicted in FIG. 4.

Many of the features that cooperate between the adapter sleeve 240 and the alignment body 255 may be used for the respective connection ports. The main differences between adapter sleeves 245 for different external fiber optic connectors are in the adapter sleeve inner bore and other structure related to the respective adapter for supporting the mating with different external connector mating footprints. Another difference is that an alignment body 255 cooperates with an adapter sleeve that is configured for mating a standard fiber optic connector such as a SC connector for a single-fiber optical connection ports using a precision alignment sleeve for aligning mating ferrules. Whereas alignment body 255 of multi-fiber connection ports cooperates with multi-fiber ferrule 30 that is secured to the alignment sleeve 240 using spring push 30SP and retainer 30R and biased to a forward position by resilient member 30RM and uses alignment pins for mating with a complimentary multi-fiber ferrule.

Adapter body 255M may have other differences in addition to the first connector stop (FCS) or exclusion height EH as discussed above for inhibiting the damaging insertion of non-compatible external connector suitable for the single-fiber drop connection port.

Alignment sleeve 240 may also include one or more windows 260W (or other feature) for cooperating with retaining features on the spring push 262P for retaining the ferrule 260A and resilient member in the adapter 260A. Ferrule stop 260FS also defines a ferrule window 260FW for coarse alignment of the ferrule 30 within the adapter 260A. In this embodiment, the ferrule window 260FW is a rectangular opening sized for an MT ferrule, but other shapes or sized may be used depending on the type of connector supported by the second connector port 260.

The front portion of passageway 260P may also comprise a connector housing alignment feature 260AF. Connector housing alignment feature 260AF is sized and shaped for cooperating receiving a front portion of the housing of the second external connector intended to be received within second connector port 260 as shown in FIG. 23, which also aids in alignment of multi-fiber ferrules so that alignment pins 30AP may properly align and engage during mating. Adapter 260A may also include a stepped or profiled rim 260RM that cooperates with a seat on the adapter body 255M for properly aligning and seating the adapter 260A in place before being secured in position. Adapter 260 may also comprise an orientation feature 260OF for aligning with the retainer 240 and may only allow assembly in one orientation if desired.

FIGS. 5 and 6 depict views of the securing member 310M that forms a portion of securing feature 310. In the explanatory embodiment, securing member 310M is used with both the multi-fiber connection ports and the single-fiber connection ports, but other variations of securing members are possible using concepts disclosed.

Securing member 310M comprises a locking feature 310LF as shown. Locking feature 310LF is configured for engaging with a suitable locking portion on the housing of a proper external connector when fully inserted. In this embodiment, securing feature 310 comprise a bore 310B that is respectively aligned with the respective connector port passageway 233 as shown when assembled. Illustratively, the bore 310B is sized for receiving a portion of an external connector such as multi-fiber connector 270 therethrough or the external single-fiber connector. As shown, the bore 310B has a closed perimeter.

In this embodiment, the locking feature 310LF is disposed within bore 310B of securing member 310M. As shown, locking feature 310LF is configured as ramp that runs to a short flat portion, then to a ledge for creating the retention surface for engaging and retaining an external connector 270 once it is fully-inserted into the connector port passageway 233 of the respective connection port 260IN, 230A, 260P. Other geometry is possible with the securing feature if desired. Consequently, the securing feature 310 is capable of moving to an open position (OP) when inserting a suitable connector into the connector port passageway 233 since the connector housing engages the ramp 310RP pushing the securing feature downward during insertion.

Locking feature 310LF cooperates with a portion of the external connector when it is fully-inserted into the respective connection port for securing the proper external connector inserted into the connection port.

Securing member 310M may also comprises a standoff as best shown in FIG. 6. Standoffs cooperate with the resilient member pocket 255SP of the alignment block 255 for keeping the bore 310B in the proper rotational orientation within the respective to the alignment block 255. Specifically, standoffs and the resilient member pocket may have curved shapes that only allow the securing member 310M to fully-seat into the alignment block 255 when oriented in the proper orientation. Standoffs also provide a retention of an optional resilient member 310RM for biasing the securing member 310M to the retain position.

In this embodiment, the securing feature 310 comprises a bore 310B that is aligned with the respective connection port passageways 233 when assembled as best shown in FIG. 5. Bore 310B is sized for receiving a suitable connector therethrough for securing the same for optical connectivity. Bores or openings through the securing feature 310 may have any suitable shape or geometry for cooperating with its respective connector. As used herein, the bore may have any suitable shape desired including features on the surface of the bore for engaging with a connector. Bore 310B is disposed on the securing member 310M in this embodiment, and the locking feature 310LF is integrally formed within the bore, but other constructions may be possible.

In some embodiments, a portion of the securing feature 310 is capable of moving to an open position when inserting a suitable connector into the respective connection port passageway 233. When the suitable connector is fully-inserted into the respective connector port passageway 233, the securing feature 310 such as the securing member 310M is capable of moving to the retain position automatically. Consequently, the proper external connector is secured within the respective connection port by securing feature 310 without turning a coupling nut or a bayonet like the prior art terminals. Stated another way, the securing feature 310 translates from the retain position to an open position as a suitable connector is inserted into the connection port. Although, the securing feature passageway 245 is arranged transversely to a longitudinal axis LA of the terminal 200 other arrangements are possible. Other securing features may operate in a similar manner but use an opening instead of a bore that receives the connector therethrough.

As best shown in FIG. 6, structure of the actuator 310A may cooperate with securing member 310M. Actuator 310A comprises a finger for seating within a rim of securing member 310M for transferring forces to the same. As depicted, a sealing feature 310S is disposed on the securing feature 310. Sealing feature is depicted and provides a seal between a portion of the securing feature 310 and the securing feature passageway 245 to inhibit dirt, dust and debris from entering the device. As shown, the sealing feature is disposed within a groove of actuator 310A. Actuator 310A may also have a stop surface that acts to keep the actuator intact with the terminal 200. Actuator 310A may also include a dimple or other feature for inhibiting inadvertent activation/translation of the securing feature 310 or allowing a tactical feel for the user.

Actuator 310A may also be a different color or have a marking indicia for identifying the port type. For instance, the actuator 310A may be colored red for input connection port 260IN and the actuator 310A for the output drop connection ports 230A-230D may be colored black. Other color or marking indicia schemes may be used for pass-through ports, multi-fiber ports or ports for split signals. The concepts disclosed may be used with other actuators as desired. For instance, the actuators may laterally slide or rotate for translating the securing member 310M if desired, instead of having a vertical translation.

To assemble the multifiber connector 30 to the adapter sleeve 240 the optical fibers are attached and finished within the ferrule 30, and then the alignment pins 30AP may be attached to the ferrule. Next the ferrule 30 with the alignment pins 30AP may be inserted into the adapter sleeve 240 and the resilient member 30RM and spring push 30SP are threaded onto the optical fibers an inserted into a rear end of the adapter sleeve 240, and the spring push 30SP and retainer 30R are attached to the adapter sleeve 240 to bias the ferrule 30 to a forward position within the adapter sleeve 240. Securing member 310M and securing feature resilient member 310RM may be positioned in the second alignment body 255 as shown.

Shells 210 may have any suitable shape, design or configuration as desired. Second portion 210B cooperates with first portion 210A to form shell 210. Second portion 210B comprises at least one single-fiber connection port 236 and at least one multi-fiber connection port 260. Second portion 210B provides a portion of cavity 216 of terminal 200, and the internal bottom surface of second portion 210B comprises a plurality of alignment features 210AF for aligning the alignment block 255 with the respective connection port passageways 233 when assembled. Likewise, the internal bottom surface of second portion 210B comprises alignment features 210AF for aligning the multi-fiber modular adapter sub-assembly 310MSA with the respective multi-fiber connection ports 260. Alignment features 210AF may have a U-shape and cooperate with the alignment features 255AF on the bottom of alignment block 255, but other structures are possible such as pins and holes. Alignment features may allow small movement for assembly and alignment.

The connection port passageways 233 may also have a keying portion as desired. By way of explanation, the keying portion may be an additive keying portion to the primitive geometric round shape of the connection port passageway 233 such as a male key that is disposed forward of the securing feature in the respective connection port. However, the concepts for the connection ports of terminals may be modified for different connector designs. For instance, the keying portion may be defined as a walled-portion across part of the connection port passageway. Thus, the connection port with keying portion would be able to properly receive an external fiber optic connector having a portion with a proper D-shaped portion. Either way the keying portion on the connection port provides further features for inhibiting the damaging insertion on non-compliant external connectors.

Thus, terminal 200 has respective adapter sleeves 240 associated with each respective connection port for receiving respective internal ferrules in alignment with the respective connection port for making the optical connection with the suitable external fiber optic connector.

Alignment body 255 may also comprises a keying portion 255K for rotationally orientating the adapter sleeve 240 with the alignment body 255. For instance, alignment body 255 may have a keyway and the adapter sleeve 240 may have a key for cooperating with the keyway, or vice versa.

In this configuration, the alignment sleeve 240 is longer than the alignment body 255 for providing extend length stability and support for the optical mating of the multifiber ferrule. As shown, the adapter 260A overlaps with the adapter body 255M for a majority of its length. Further, the alignment sleeve 240 is configured as an inner barrel comprising a first connector stop (FCS) as desired for inhibiting the damaging insertion of non-compliant external connectors and extends past the rear end 255R of the alignment block 255 when assembled. The adapter sleeve 240 is assembled into the respective alignment body passageway 255P from the front side of the adapter body 255M. Adapter 260A may be biased to the forward position by resilient member 249. This alignment body 255 may also include an stop surface 255S such as a shoulder that acts as a stop for the alignment sleeve 240 insertion depth. For instance, each of the respective alignment block passageways 255P may comprise a respective stop surface or shoulder disposed between the forward end 255F and the rearward end 255R of the alignment block.

As discussed, the multifiber modular adapter sub-assembly 310MSA shown comprises the first connector stop (FCS) or single-fiber connector stop (SFCS) for inhibiting the damaging insertion of non-compatible external connector into the multifiber optical connection port of the terminal 200. The one or more components that comprise the first connector stop may use an exclusion height (EH) tailored to inhibit damaging insertion of a non-compliant connector into the respective connection port. The use of the exclusion height (EH) inhibits the non-compliant external connector from damaging the ferrule associated with connection port 260. Thus, if the technician mistakenly attempts to insert the non-compliant external connector into connection port 260, then the non-compliant external connector is inhibited from damaging the mating face of the ferrule 30 of connection port 260. The exclusion height (EH) may have any suitable size such as 5.5 millimeters or less for inhibiting the damaging insertion of the first connector that is configured as single-fiber connector with a SC-type front portion into the single-fiber drop output connection ports. In other embodiments, the exclusion height (EH) may comprises a range of between 5.5 millimeters and 2.5 millimeters, thereby inhibiting the damaging insertion of the non-compliant external connector into the multifiber connection port, but allowing a proper external connector to make optical communication at the multifiber connection port.

FIG. 7 shows explanatory alignment body 255M having multiple sleeves ganged together alignment body passageways 255P in a common component for assembling a plurality multi-fiber and/or single-fiber modular sub-assemblies with the adapter body 255 before assembly within the terminal 200. Alignment body 255 of FIG. 7 receives a plurality of adapter sleeves 240 within respective passageways 255P.ng with an organized arrangement for the multi-fiber connection ports 260 and external connectors attached to the terminals 200. FIG. 14 shows the disclosed concepts using a single barrel alignment block 255 for receiving a single alignment sleeve 240 for supporting a multi-fiber connection port.

Shells have a given height H, width W and length L that define a volume for the terminal as depicted in FIG. 2. By way of example, shells 210 of terminal 200 may define a volume of 800 cubic centimeters or less, other embodiments of shells 210 may define the volume of 400 cubic centimeters or less, other embodiments of shells 210 may define the volume of 100 cubic centimeters or less as desired. Embodiments of terminals 200 comprise a port width density of at least one s multi-fiber connection port 260 per each 25 millimeters of width W of the terminal 200. Other port width densities are possible such as at least one multi-fiber connection port 236 per each 20 millimeters of W of terminal 200 or at least one multi-fiber connection port 236 per each 15 millimeters of width W of the terminal. Likewise, embodiments of terminals 200 may comprise a given density per volume of the shell 210 as desired.

By way of example and not limitation, the terminals disclosed herein may define a volume of 400 cubic centimeters or less for 12-ports, or even if double the size could define a volume of 800 cubic centimeters or less for 12-ports. Terminals with smaller port counts such as 4-ports could be even smaller such as the shell or terminal defining a volume of 200 cubic centimeters or less for 4-ports, or even if double the size could define a volume of 200 cubic centimeters or less for 4-ports.

One of the reasons that the size of the terminals may be reduced in size with the concepts disclosed herein is that the connectors that cooperate with the terminals have locking features that are integrated into the connector housing of the external connectors received in multi-fiber connection ports. In other words, the locking features for securing connector are integrally formed in the housing of the external connector, instead of being a distinct and separate component like a coupling nut of a conventional hardened connector used with conventional multiport terminals. Also eliminating the dedicated coupling nut from the conventional connectors also allows the footprint of the connectors to be smaller, which also aids in reducing the size of the terminals disclosed herein.

Terminals may have other constructions, features or components using the concepts disclosed. For instance, terminals may also have one or more dust plugs for protecting the multi-fiber and single-fiber connection port(s) from dust, dirt or debris entering the terminal or interfering with the optical performance. Thus, when the user wishes to make an optical connection to the terminal, the appropriate dust plug is removed from the connector port and then external plug connector of the desired cable assembly may be inserted into the respective connection port for making an optical connection to the terminal. Dust plugs may use similar release and retain features as the external connectors. By way of explanation, when securing feature 310 is pushed inward or down, the dust plug is released and may be removed. Moreover, the interface between the connection ports and the dust plug or external connector may be sealed using appropriate geometry and/or a sealing element such as an O-ring or gasket.

Terminal 200 or devices may comprise mounting features that are integrally formed in the shell 210 or that are separate components attached to shell 210 for mounting the device. By way of example, FIG. 2 depicts shell 210 having mounting features 210MF disposed near first and second ends 212, 214 of shell 210. Mounting feature 210MF adjacent the first end 212 of terminal 200 is a mounting tab 298 attached to shell 210, and the mounting feature 210MF adjacent the second end 214 is a through hole with a support 210S. However, mounting features 210MF may be disposed at any suitable location on the shell 210 as desired. For instance, terminal 200 also depicts a plurality of mounting features 210MF integrally-formed on shell 210 and configured as passageways disposed on the lateral sides. Thus, the user may simply use a fastener such as a zip-tie threaded thru these lateral passageways for mounting the terminal 200 to a wall or pole as desired.

The terminals disclosed are simple and elegant in their designs. The terminals disclosed comprise at least one second connection port such as a multi-fiber connection port comprising an optical connector opening extending toward a cavity of the terminal and defining a multi-fiber connection port passageway that may receive a multi-fiber plug connector for optical connection. The multi-fiber connection port inhibits the damaging insertion of the external connector suitable for optically mating with the first connection port of the terminal such as a single-fiber plug connector intended for the at least one single-fiber connection port if mistakenly attempted to be inserted into the second connection port. As used herein, the first connection port and the second connection port support different external optical connectors for mating and making and optical connection. Terminals disclosed may have other active or passive components as desired. For instance, the concepts disclosed may be used with wireless devices having a similar construction to the concepts disclosed herein and comprising at least one single-fiber connector port and at least one multi-fiber connection port. If the terminal is configured as a wireless device the input port may include power and may have electronics disposed with in the cavity (not visible) of the terminal. The terminal configured as the wireless device may have any of the other features disclosed herein and they will not be repeated for the sake of brevity.

Although the disclosure has been illustrated and described herein with reference to explanatory embodiments and specific examples thereof, it will be readily apparent to those of ordinary skill in the art that other embodiments and examples can perform similar functions and/or achieve like results. For instance, the connection ports may be configured as individual sleeves that are inserted into a passageway of a device, thereby allowing the selection of different configurations of connector ports for a device to tailor the device to the desired external connector(s). Additionally, wiring schemes can be duplicated such as having two input connection ports each being wired to a dedicated multifiber output connection port. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

We claim:

1. A terminal (200) for making a multi-fiber optical connection at an input connection port of the terminal, the terminal comprising:
a shell (210) defining a cavity (216);
the input connection port (260IN) supporting a plurality of input optical fibers (92IN) sequentially numbered 1 to X and disposed within the cavity of the shell, the plurality of input optical fibers sequentially numbered 1 to X being disposed in an input multi-fiber ferrule (30) comprising a plurality of optical fiber openings sized for receiving the respective input optical fibers sequentially numbered 1 to X into the plurality of optical fiber openings of the input multi-fiber ferrule (30) that are numbered sequentially from 1 to X;
wherein a wiring scheme of the terminal comprises a D-number of output drop connection ports (230A-230D):
the D-number of output drop connection ports (230A-230D) terminating the respective input optical fibers sequentially numbered from 1 to the input optical fiber sequentially numbered D for routing to the optical connection at the respective output drop connection port (230A-230D);
a first multifiber output connection port (260) terminating the respective input optical fibers sequentially numbered from D+1 input optical fiber to the input optic fiber sequentially numbered the X input optical fiber of the plurality of input optical fibers for optical connection at the first multifiber output connection port, the plurality of input optical fibers sequentially numbered D+1 to X being disposed in an output multi-fiber ferrule comprising a plurality of optical fiber openings sized for receiving the respective input optical fibers sequentially numbered D+1 to X into the plurality of optical fiber openings of the output multi-fiber ferrule numbered sequentially from D+1 to X.

2. The terminal of claim 1, wherein the D-number of output drop connection ports (230A-230D) each provides optical connectivity to a single input optical fiber.

3. The terminal of claim 1 comprising an optical connection from the first multifiber output connection port to a second input connection port of a second terminal, the second input connection port supporting a plurality of second input optical fibers sequentially numbered 1 to X disposed within the cavity of a shell.

4. The terminal of claim 1, wherein a portion of the first multifiber output connection port is formed as a portion of the shell.

5. The terminal of claim 1, further comprising a second terminal comprising a second terminal multifiber input connection port that is optically connected to the first multifiber output connection port for sequentially optically connecting to the second terminal input optical fibers sequentially numbered 1 to Y at the second terminal multifiber input connection port.

6. The terminal of claim 5, wherein a wiring scheme of the second terminal comprises:
a second terminal multifiber output connection port sequentially terminating 1 to Z of the second terminal input optical fibers sequentially numbered 1 to Y for optical connection at the second terminal multifiber output connection port;
a first pass-through output connection port terminating the second terminal optical fiber sequentially numbered Y−1 for optical connection at the second terminal first pass-through output connection port; and
a second pass-through output connection port terminating the second terminal input optical fiber sequentially numbered Y for optical connection at the second terminal second pass-through output connection port.

7. The terminal of claim 1, further comprising a third terminal comprising a third terminal multifiber input connection port that is optically connected to the second terminal multifiber output connection port for sequentially optically connecting to the second terminal input optical fibers sequentially numbered 1 to A at the third terminal multifiber input connection port.

8. The terminal of claim 1, the terminal further comprising at least one securing feature (310) being associated with the first multifiber output connection port configured for securing an external fiber optic connector, and at least one securing feature resilient member (310RM) for biasing a portion of the at least one securing feature (310).

9. The terminal of claim 8, wherein of the at least one securing feature (310) is biased to a retain position (RP).

10. The terminal of claim 8, wherein the at least one securing feature (310) comprises a bore (310B) that is aligned with the at least one connection port passageway (233).

11. The terminal of claim 1, wherein the first multifiber output connection port comprises a multi-fiber adapter body (255M) or an adapter (260A) having a single-fiber connector stop (SFCS), wherein the single-fiber connector stop (SFCS) is sized for inhibiting the damaging insertion of non-compatible single-fiber plug connector into the at least one multifiber connector port (260).

12. The terminal of claim 11, wherein the multi-fiber adapter body (255M) comprises a passageway, wherein a portion of the passageway comprises an exclusion height (EH) of 5.5 millimeters or less.

13. The terminal of claim 12, wherein the multi-fiber adapter body (255M) receives the adapter (260A), and the adapter (260A) is configured as an inner barrel that is received from the front side of the multi-fiber adapter body (255M).

14. The terminal of claim 8, wherein the at least one securing feature (310) is capable of moving to a retain position (RP) automatically when a suitable fiber optic connector is fully-inserted.

15. The terminal of claim 8, wherein the at least one securing feature (310) further comprises a locking feature (310L).

16. The terminal of claim 15, wherein the locking feature (310L) comprises a ramp with a ledge.

17. The terminal of claim 8, wherein the securing feature (310) comprises an actuator (310A) and a securing member (310M).

18. The terminal of claim 1, further comprising at least one optical splitter (275) or at least one wave-division multiplexer disposed within the cavity (216).

19. The terminal of claim 1, the at least one multi-fiber connection port (260) comprising a keying portion (233KP).

20. The terminal of claim 19, wherein the keying portion (233KP) comprises a male key.

21. The terminal of claim 1, further comprising—an alignment block (255) comprising a first alignment block passageway (255P) extending between a forward end (255F) and a rearward end (255R) of the alignment block (255); and
an adapter sleeve (240) comprising a passageway (240P) from a front end (241) to a rear end (243) and sized for being received within the first alignment block passageway (255P), and the adapter sleeve (240) comprising a length (L), wherein a majority of the length (L) of the adapter sleeve (240) is disposed within the first alignment block passageway (255P) when assembled for providing side-stability for the optical mating of the multifiber ferrule (30) associated with the at least one multi-fiber connection port (260).

22. The terminal of claim 21, further comprising an adapter sleeve biasing member (249) disposed between the alignment block (255) and the adapter sleeve (240).

23. The terminal of claim 21, wherein the rear end (243) of the adapter sleeve (240) extends the beyond the rearward end (255R) of the alignment block (255).

24. The terminal of claim 21, wherein the first alignment block passageway (255P) comprising a shoulder (255S) disposed in the between the forward end and the rearward end.

25. The terminal of claim 21, wherein the alignment block (255) comprises a plurality of alignment block passageways (255P) extending between a forward end (255F) and a rearward end (255R) of the alignment block (255), and each of the plurality of alignment block passageways (255P) comprising a respective shoulder (255S) disposed between the forward end (255F) and the rearward end (255R).

26. The terminal of claim 21, wherein the at least one multi-fiber connection port (260) is associated with a securing feature (310).

27. The terminal of claim 21, wherein a forward portion of the alignment block (255) comprises a pocket (255P) for receiving a portion of the securing feature resilient member (310M).
